(19) United States
(12) Patent Application Publication
(10) Pub. No.: US 2024/0070470 A1
(43) Pub. Date: Feb. 29, 2024

(54) TRAINING OF LSTM NEURAL NETWORK TO MODEL AND PREDICT APPLICATION LOG SEQUENCES

(71) Applicant: Royal Bank of Canada, Toronto (CA)

(72) Inventors: Reece BAJNATHSINGH, Waterloo (CA); Milad REZAEE, Milton (CA); Farah AMER, Toronto (CA); Garret LACEY, Markham (CA)

(21) Appl. No.: 18/235,646

(22) Filed: Aug. 18, 2023

Related U.S. Application Data
(60) Provisional application No. 63/400,663, filed on Aug. 24, 2022.

(51) Int. Cl. G06N 3/0985; G06N 3/0442

(52) U.S. Cl. CPC G06N 3/0985; G06N 3/0442

(57) ABSTRACT

A method for training a neural network utilizing Long Short-Term Memory (LSTM) to model a computer application log as a natural language sequence comprises feeding a training set of application log files to a log file parser, generating, by the log file parser, a set of X application log clusters, where X is a whole number, feeding the whole number X to an untrained LSTM neural network as a hyperparameter representing a number of classes, and training the untrained LSTM neural network using the training set of log files and the hyperparameter X to obtain a trained LSTM neural network.

### CROSS-REFERENCE TO RELATED APPLICATIONS

This application claims priority to U.S. Provisional Application No. 63/400,663 filed on Aug. 24, 2022 and which is incorporated herein by reference.

### TECHNICAL HELD

The present disclosure is directed toward artificial intelligence, and more specifically to training of machine learning models used to predict incidents in computer applications.

### BACKGROUND

An approach for anomaly detection and diagnosis from application logs through deep learning is described in the article “DeepLog: Anomaly Detection and Diagnosis from System Logs through Deep Learning” by Min Du, Feifei Li, Guineng Zheng, Vivek Srikumar, CCS' 17, Oct. 30-Nov. 3, 2017, Dallas, TX, USA; DOI: http://dx.doi.org/10.1145/3133956.3134015 and available at https://www.cs.utah.edu/˜lifeifei/papers/deeplog.pdf, (the “DeepLog Paper”) which is hereby incorporated by reference in its entirety. This approach is implemented in open source projects, available under the MIT License at https://github.com/Thijsvanede/DeepLog and at https://github.com/wuyifan18/DeepLog (collectively the “DeepLog Code”) and also incorporated by reference in its entirety. The model implementation in the DeepLog Code comprises a PyTorch Long Short-Term Memory (LSTM) neural network and a PyTorch Linear layer (PyTorch is a deep learning tensor library based on the Python programming language and the Torch machine learning library).

Broadly speaking, the DeepLog model deploys a deep learning algorithm that learns commonly occurring log sequences from historical log data. The model ingests a sequence of application logs and examines them in sliding windows of fixed length. The model looks at a sequence of logs and predicts the next logs that are likely to occur in that sequence. If the actual observed log does not fall within the prediction, then the sequence is flagged as an anomaly. Where an application is producing logs in unexpected sequences (i.e. sequences that are not commonly produced), this can be seen as a possible precursor to future errors.

When initializing a DeepLog model using the DeepLog Code, the programmer is required to provide certain hyperparameters. These include:
input_size: the number of expected features in the input
hidden_size: the number of features in the hidden state of the model
num_layers: the number of recurrent layers
num_classes: this corresponds to the number of “out_features” in the Linear layer or the size of each output sample; this is also known as the number of classes in the multi-class classification problem (as outlined by the DeepLog Paper)

Let ‘K’ be the set of all distinct log templates from the system source code for which the DeepLog model is being trained. Log templates are strings which represent the string constant of a raw log statement with the variable parts masked so that similar types of logs can be clustered together and represented by an identifying number, referred to as a “log template number”. Let ‘w’ be an input sequence of log template numbers and ‘m’ be the next log template number in the sequence. (Note that ‘w’ and ‘m’ are subsets of K). The output of the DeepLog model is a probability distribution: Pr(m=k|w) for each k in the set K (where ‘k’ is a log template number in the set K). With an unrepresentative training set, the size of K (denoted |K|) is not known and is subject to change. Similarly, source code changes can also affect the value of |K|. However, when initializing the DeepLog model, the value of |K| must be known beforehand. Without a sufficiently representative training set, the value of |K| cannot be determined beforehand, and the value of |K| may change if the source code changes, undermining the accuracy of the DeepLog model.

### SUMMARY

In one aspect, a method for training a neural network utilizing Long Short-Term Memory (LSTM) to model a computer application log as a natural language sequence comprises feeding a training set of application log files to a log file parser, generating, by the log file parser, a set of X application log clusters, where ‘X’ is a whole number, feeding the whole number X to an untrained LSTM neural network as a hyperparameter representing a number of classes, and training the untrained LSTM neural network using the training set of log files and the hyperparameter X to obtain a trained LSTM neural network.

A computer-implemented method for detecting anomalous behaviour in a computer system may comprise receiving a real-time stream of application log entries, extracting a sequence of application log entries from the stream, applying a model comprising the trained LSTM neural network described above to the sequence of application log entries to generate a prediction for a predicted next application log entry, comparing an actual next application log entry to the prediction, and, responsive to determining that the actual next series of application log entries is outside of the prediction, flagging the actual next application log entry as an anomaly.

The series of application log entries may be extracted by applying a sliding window of fixed length to the stream of application log entries.

In other aspects, the present disclosure is directed to data processing systems and computer program products for implementing the above-described methods.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 shows a computer network that comprises an example embodiment of a system for using machine learning for training and use of machine learning models to predict incidents in computer applications;

FIG. 2 depicts an example embodiment of a server in a data center;

FIG. 3 is a flow chart showing an illustrative method for training a neural network utilizing Long Short-Term Memory (LSTM) to model a computer system log as a natural language sequence;

FIG. 4 is a flow chart showing a computer-implemented method for detecting anomalous behaviour in a computer system, using an LSTM neural network;

FIG. 5 shows an illustrative architecture for a system according to an aspect of the present disclosure;

FIG. 6 shows a schematic representation of a method for training a neural network utilizing LSTM to model a computer application log as a natural language sequence; and

FIG. 7 shows a schematic representation of a method for detecting anomalous behaviour in a computer system.

### DETAILED DESCRIPTION

Broadly speaking, the present disclosure describes a system, method and computer program product to train a neural network utilizing a Long Short-Term Memory (LSTM) model to model a computer application log as a natural language sequence, and the use of the trained model to predict anomalies.

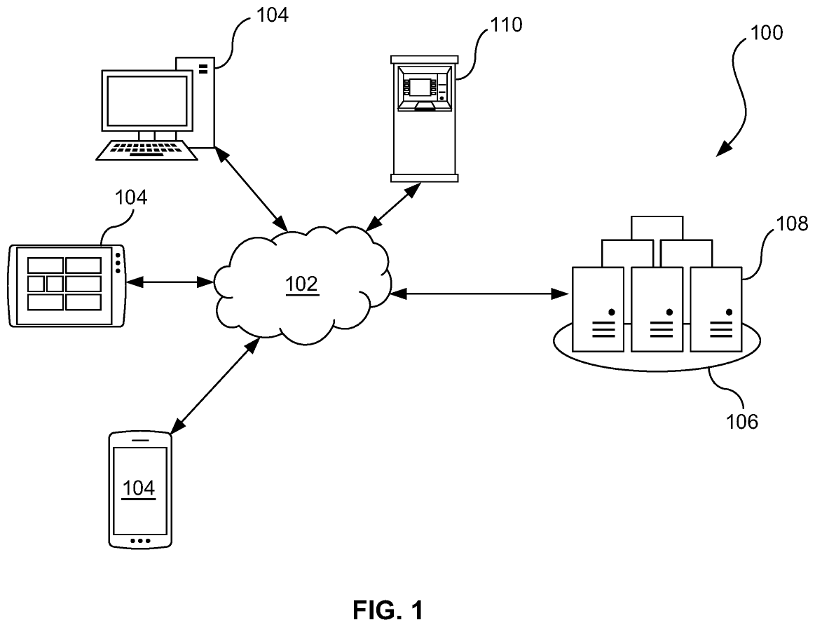

Referring now to FIG. 1, there is shown a computer network 100 that comprises an example embodiment of a system that may incorporate a neural network utilizing an LSTM model to model a computer application log as a natural language sequence, and then use the trained model to predict anomalies. More particularly, the computer network 100 comprises a wide area network 102 such as the Internet to which various client devices 104, an automatic teller machine (ATM) 110, and data center 106 are communicatively coupled. The data center 106 comprises a number of servers 108 networked together to collectively perform various computing functions. For example, in the context of a financial institution such as a bank, the data center 106 may host online banking services that permit users to log in to those servers 108 using user accounts that give them access to various computer-implemented banking services, such as online fund transfers. Furthermore, individuals may appear in person at the ATM 110 to withdraw money from bank accounts controlled by the data center 106. One or more of the servers 108 in the data center 106 may implement the LSTM neural network to monitor one or more applications in the data center 106 to identify anomalies, so that preventive action can be taken to avoid incidents that can affect performance and/or availability of the application(s). Although the illustrative data center 106 may host online banking services, this is merely a non-limiting example, and the LSTM neural network technology described herein may be applied in a wide range of computer application contexts.

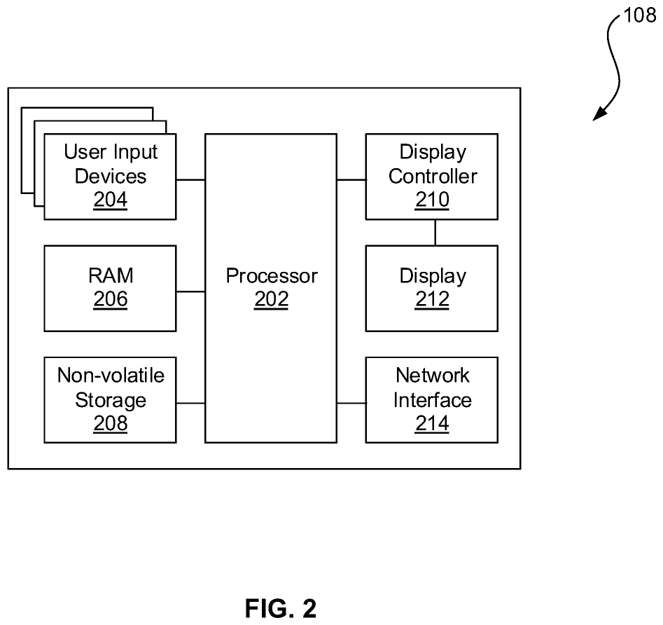

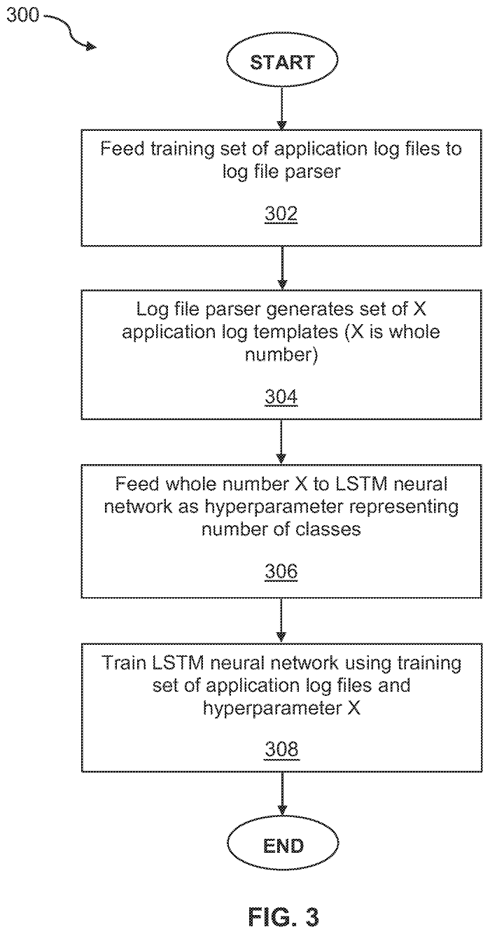

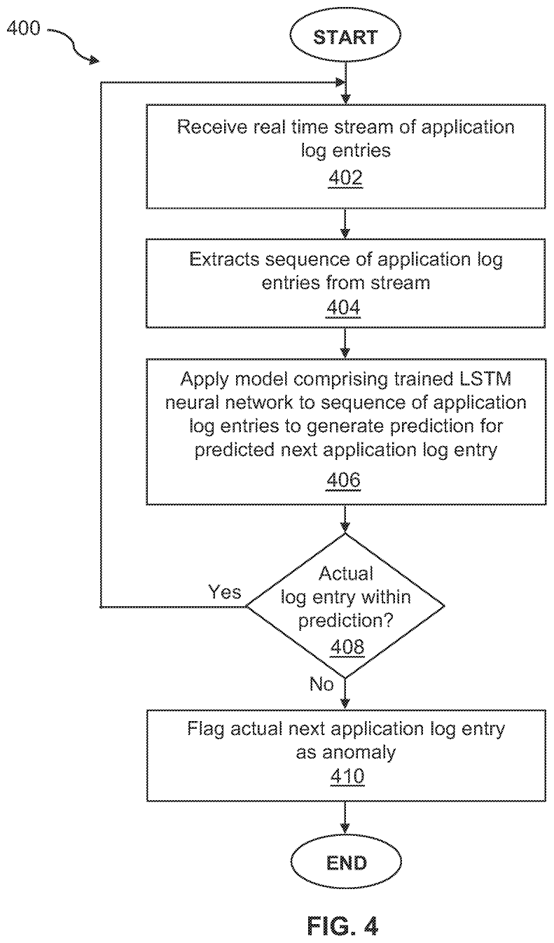

Referring now to FIG. 2, there is depicted an example embodiment of one of the servers 108 that comprises the data center 106. The server comprises a processor 202 that controls the overall operation of the server 108. The processor 202 is communicatively coupled to and controls several subsystems. These subsystems comprise user input devices 204, which may comprise, for example, any one or more of a keyboard, mouse, touch screen, voice control; random access memory (“RAM”) 206, which stores computer program code for execution at runtime by the processor 202; non-volatile storage 208, which stores the computer program code executed by the processor 202 at runtime; a display controller 210, which is communicatively coupled to and controls a display 212; and a network interface 214, which facilitates network communications with the wide area network 102 and the other servers 108 in the data center 106. The non-volatile storage 208 has stored on it computer program code that is loaded into the RAM 206 at runtime and that is executable by the processor 202. When the computer program code is executed by the processor 202, the processor 202 causes the server 108 to train an LSTM neural network, and then use the trained neural network to predict anomalies, as described in more detail in respect of FIGS. 3 and 4 below. Additionally or alternatively, the servers 108 may collectively perform that method using distributed computing. While the system depicted in FIG. 2 is described specifically in respect of one of the servers 108, analogous versions of the system may also be used for the client devices 104.

Log files accumulated during the early stages of operation of a computer system, or an application within a computer system, will typically represent only a subset of the possible log files. If using an LSTM neural network model to detect anomalies, the model needs to constantly be trained on the newest log files obtained to eventually learn a representative set of the log files and increase in accuracy. Furthermore, to maintain performance it should be periodically trained on the newest log files to adapt to changes in source code that may result in new log files (new log templates) and new sequences emerging. As such, there is a need to dynamically determine the value of |K|, that is, the size of the set K of all distinct log templates from the system source code for which the model is being trained. In the illustrative embodiment using the DeepLog model, the value of |K| corresponds to the parameter “num_classes” when initializing the model during training on a new set of log files.

Reference is now made to FIG. 3, which shows an illustrative method 300 for training a neural network utilizing LSTM to model a computer system log as a natural language sequence. The method 300 may be used in training the DeepLog model as described in the DeepLog Paper and implemented in the DeepLog Code, and more particularly where there is a new set of training files to be used to train a new model. However, the method 300 is not necessarily limited to the DeepLog model.

At step 302, the method 300 feeds a training set of application log files to a log file parser. The log file parser may be, for example, the IBM® Drain3 parser, available at https://github.com/IBM/Drain3 under the MIT License and incorporated herein by reference in its entirety, with suitable adaptation for the particular computer system from which the log files originate.

At step 304 of the method 300, the log file parser generates a set of X application log templates, where X is a whole number. Where the IBM Drain3 parser is used, each log template number corresponds to a log template that has been assigned by the IBM Drain3 parser. Consequently, |K| is equivalent to the number of log clusters that the IBM Drain3 parser recognizes after training on a specific set of training files containing logs. Thus, in one embodiment, the parser is trained on raw application log data to create a parser state which can be used for transforming raw logs into log templates. Log templates describe “clusters” of logs; log templates are strings which represent the common string constant of a raw log statement with the variable parts masked so that similar types of logs can be clustered together. Each log template describes a particular log cluster. For example, the log statement:
Received response in 3 seconds
   may be matched to the template:
Received response in <*> seconds
   where <*> is a placeholder for the variable parameter. Each log template can be assigned a log template number. Since a log template describes a cluster of logs, the terms “log template number” and “log cluster number” may be used interchangeably.

A range of raw application log files is selected for use as a training set for the log data (the files can be manually chosen, or all the raw files currently available may be used, or the subset of the raw files used to train the previous model could be used, e.g. for hyperparameter training using the same dataset). The raw log data files are transformed into an intermediate file.

First, the logs are grouped by timestamp: a time window is passed to a function which is used to group the raw application logs. For example, if the time window is set to one second, then the function may create a file where all the logs that fall within a one-second time window are grouped together on one line. The parser also converts the log to a template which is identified by an integer and instead of writing the raw log to the file, the integer is written instead. For example, given the following log sequence:
12:00:00 Created block in 3 seconds
12:00:01 Received response in 2 seconds
12:00:02 Deleted block successfully
   these logs match the log templates and their log template number in the trained parser as follows:
<TIME> Created block in <*> seconds [log template number: 1]
<TIME> Received response in <*> seconds [log template number: 2]
<TIME> Deleted block successfully [log template number: 3]
   The logs are grouped by time window and written to an output file as follows:
1 2 3
   and feature extraction can now be performed by sampling from the intermediate file using sliding windows of fixed sizes to create a file with fixed length sequences of log template numbers on each line.

For example, given the following input file:
1 2 3 4
6 7
   and given a window size of three (3), a TensorDataset may be generated in PyTorch and fed to the model, with feature vectors on each line as follows:
1 2 3
2 3 4
6 7

This training file may be used to train a machine learning model, specifically an LSTM neural network model, and in a particular embodiment an LSTM neural network adapted from the DeepLog model.

Of note, each log template number (e.g. integers 1, 2, 3, 4, 5, 6, 7) corresponds to a log template for a cluster of logs that has been assigned by the parser. Consequently, |K| is equivalent to the whole number X of log clusters that the parser recognizes after training on a specific set of training files containing application logs. In a particular illustrative embodiment in which the parser is the IBM Drain3 parser, a whole number value, X, which represents the number of log clusters recognized by the parser from the provided set of training files, is extracted from the trained parser represented by a “template_miner” object. This can be done by considering a field in the template_miner object which represents a dictionary whose values are log clusters learned by the parser from the input training set. The value of X can be obtained by finding the length of the list of values in that dictionary. Again, there are X application log clusters, where X is a whole number.

At step 306, the method 300 feeds the whole number X to the LSTM neural network as a hyperparameter representing the number of classes. In the illustrative embodiment using the DeepLog model, the number X is fed as the hyperparameter, “num_classes” which was described previously, to the training function which is used to initialize and train a new instance of the DeepLog model. Accordingly, at step 308 the method 300 trains the LSTM neural network using the training set of log files and the hyperparameter X. More particularly, in the illustrative embodiment training of the DeepLog model is executed using the same training set of log files that the parser was trained on along with the hyperparameter, “num_classes” with the assigned value of X.

The hyperparameter input_size (the number of expected features in the input), may be fixed as 1 because the only feature is a sequential vector representing the sequence of log cluster numbers. In the illustrative embodiment, the hyperparameter hidden_size (the number of features in the hidden state of the model) was fixed at 64 after hyperparameter tuning experiments and the hyperparameter num_layers (the number of recurrent layers) was fixed at 2 after hyperparameter tuning experiments. These are merely illustrative examples.

The method 300 may be carried out periodically in an automated manner (e.g. at preset intervals) to continually update the LSTM neural network model.

Reference is now made to FIG. 4, which is a flow chart showing a computer-implemented method 400 for detecting anomalous behaviour in a computer system, using an LSTM neural network (e.g. the DeepLog model implemented in a Flask framework) trained according to the present disclosure. At step 402, the method 400 receives a real-time stream of application log entries. Although shown as a discrete step for purposes of flowchart illustration, in operation the method 400 receives a continuous stream of application log entries from which smaller sequences may be extracted. In one embodiment, the application that generates the logs may have a connection to a Filebeat® software implementation, which ships the application logs to a Logstash® software implementation. The Filebeat software is used to perform analytics on and monitor application performance of proprietary and open source software applications, and the Logstash software is used for collecting, managing, searching, and viewing computer activity logs. The Filebeat and Logstash software are available from Elasticsearch B.V. having a registered office at Keizersgracht 281, 1016 ED Amsterdam, the Netherlands. In one embodiment, the Logstash software implementation contains an output plugin to send the logs to an S3 (Simple Storage Service) bucket, which is set up to receive the logs from the Logstash software implementation in the form of text files which are received at time intervals as they become available. For example, the S3 bucket may be an Amazon 53® bucket provided by Amazon Technologies, Inc. having an address at 410 Terry Ave N, Seattle, WA 98109. (The approach described in this paragraph may also be used to generate the application log files used for training at step 302 of the method 300.)

At step 404, the method 400 extracts a sequence of application log entries from the stream received at step 402, and at step 406, the method 400 applies a model comprising the trained LSTM neural network generated by the method 300 to the sequence of application log entries to generate a prediction for a predicted next application log entry. At step 408 the method 400 compares the actual next application log entry to the prediction. At step 410, responsive to determining at step 408 that the actual next application log entry is outside of the prediction, the method 400 flags the actual next application log entry as an anomaly. Responsive to determining at step 408 that the actual next application log entry is within the prediction, the method 400 returns to step 402 to continue to receive the sequence of application log entries.

In one embodiment, a vector comprising a window of log template numbers of a given size is sent into the trained LSTM model and the trained LSTM model returns a vector of predicted log templates that would follow the input sequence (step 404). Thus, the sequence of application log entries is obtained by applying a sliding window of fixed length to the stream of application log entries. The top Y (where ‘Y’ is an adjustable whole number parameter) of predicted log templates (log template numbers) are compared to the actual next log entry in the sequence (steps 406 and 408). If the actual log entry does not fall within the vector (step 408), then the sequence is identified as an anomaly (step 410).

The anomalous and expected sequence of application log entries, along with their corresponding raw log messages, can be sent to a database for storage. A frontend user interface can read from the database and display the anomalous sequences of application log entries. Optionally, the top Y log numbers may be used to form the expected log entry sequences pertaining to the given input sequence of application log entries for later display on the user interface. The user interface may permit the input of debugging instructions which relate to that anomalous sequence of application log entries so that when it is identified in the future, there will be a predefined set of steps to react to that previously encountered anomaly. The user interface may take the form of a dashboard in a web application, for example.

The web application may begin on a dashboard view which shows all the flagged anomalous sequences of application log entries. These sequences can optionally be sorted, filtered, and searched based on the fields in their contents. Upon a user selecting an anomalous sequence of application log entries, the web application may proceed to a view that compares the anomalous sequence of application log entries to the predicted next series of application log entries, with the anomalous log entries highlighted for comparison. For each log entry in the detected anomalous sequence, a user may select relevant fields (e.g. hostname, operating system (OS), etc., as well as the full log message). Users may be able to manually recognize which process is behaving irregularly so they can begin debugging the situation before an incident occurs. An editable debug section of the web application may permit entry of documentation that others can follow in the future if a similar anomalous sequence of application log entries is detected.

One illustrative procedure for recovering raw log messages from the log template numbers fed into the LSTM model will now be described. The code may include a function that, while grouping logs by timestamp, generates two files in parallel: a first file (e.g. “grouped_templates.txt”) contains the log template numbers where each session (list of timestamp grouped logs) is on a separate line, and a second file (e.g. “grouped_raw.txt”) contains raw log messages, one on each line, and, following a set of application log entries that belong to the same session, a line containing a special character (e.g. “-”) is written for separation. The first file (e.g. “grouped_templates.txt”) may be used by the LSTM model for prediction, and the second file (e.g. “grouped_raw.txt”) is used to relate the log template numbers in the first file (e.g. “grouped_templates.txt”) to the original log messages. When performing predictions, both files can be read at the same time. When a sequence is generated from the first file (e.g. “grouped_templates.txt”) and used to make a prediction, the same sequence is generated from the second file (e.g. “grouped_raw.txt”) and written to a list which is stored alongside anomalous sequences of log template numbers.

In some cases, an application log entry in a file obtained for prediction by the LSTM model does not match any existing log template. In this case, the system may be configured to return a negative integer, for example “−999”, as the log template number. This negative log template number can be flagged in later processing so that the system can ignore sequences that contain application log entries that do not fit a known log template pattern on which the parser has been trained. Thus, the negative log template number is not fed into the LSTM model. However, these previously unseen application log entries can be assumed to be anomalous, and can be included in the user interface for comparison to the predicted next series of application log entries.

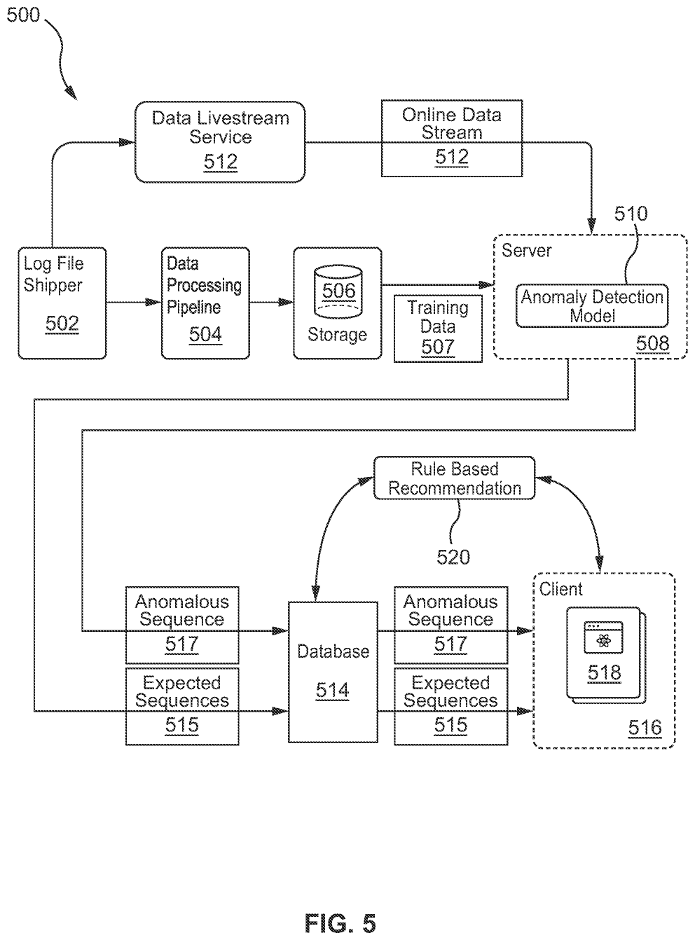

FIG. 5 shows an illustrative architecture 500 for a system according to an aspect of the present disclosure. A log file shipper 502, for example a Filebeat software implementation, forwards application log files that will be used as training data to a server-side data processing pipeline 504, for example a Logstash software implementation, which in turn forwards appropriate training data to a storage 506, for example S3 storage. The training data 507 is fed to a server 508 (which may be a plurality of server computers in cooperation) that implements an LSTM anomaly detection model 510. For example, the server 508 may be a Flask server and the LSTM anomaly detection model 510 may be a suitable implementation of the DeepLog model, such as an implementation of the DeepLog Code in cooperation with a suitable log parser such as the IBM Drain3 parser. The training data 507 is used to train the LSTM anomaly detection model 510 as described above.

The log file shipper 502 also communicates with a data livestream service 512. The data livestream service 512 may be implemented, for example, using the Apache Kafka open-source distributed event streaming platform available at https://kafka.apache.org/downloads under the Apache License 2.0 and incorporated herein by reference. The data livestream service 512 passes an online data stream 513 comprising a real-time sequence of application log entries to the server 508 for analysis by the LSTM anomaly detection model 510 executing on the server 508. The LSTM anomaly detection model 510 executing on the server 508 generates predictions for the predicted next series of application log entries (expected sequences) and identifies cases where the actual next series of application log entries is outside of the prediction; these are flagged as an anomaly (anomalous sequence). The LSTM anomaly detection model 510 executing on the server 508 passes the expected sequences 515 and any anomalous sequence 517 to a database 514 for storage. The expected sequences 515 and any anomalous sequences 517 stored on the database 514 can then be served to a client 516 that executes a web application 518 such as that described above. The web application 518 can be implemented, for example, using the React JavaScript library available at https://reactjs.org/. The database 514 may also store rule-based recommendations 520 for handling any anomalous sequences, which can be passed to the web application 518 along with the anomalous sequence; conversely, new rule-based recommendations 520 for handling a new anomalous sequence can be added to the database 514 via the web application 518.

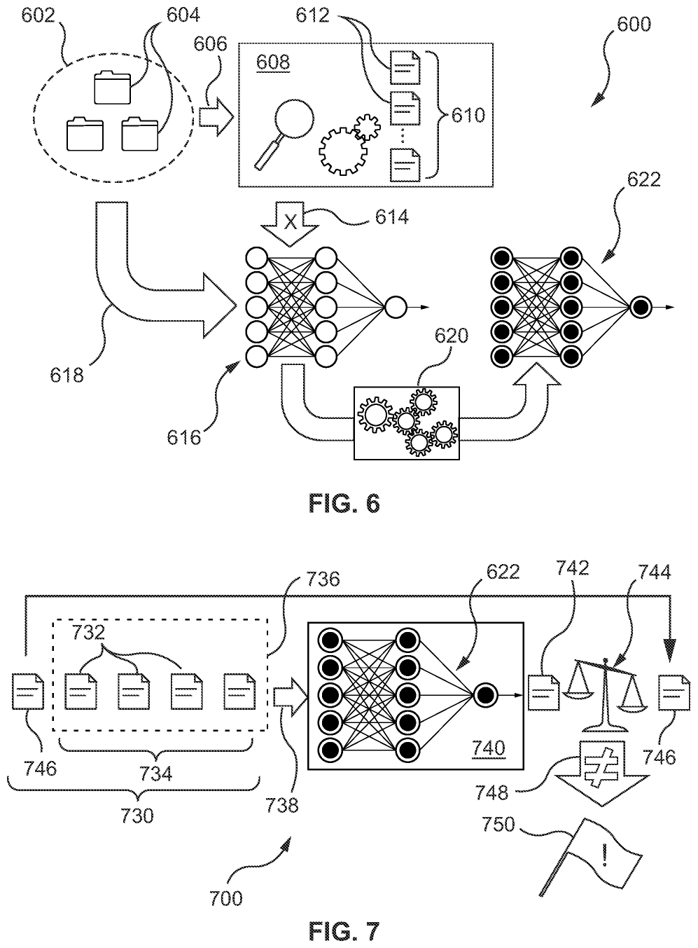

In further illustration, FIG. 6 shows a schematic representation of a method 600 for training a neural network utilizing LSTM to model a computer application log as a natural language sequence. A training set 602 of application log files 604 is fed 606 to a log file parser 608. The log file parser 608 generates a set 610 of X application log clusters 612, where X is a whole number. The whole number X is fed 614 to an untrained LSTM neural network 616 as a hyperparameter representing a number of classes, and the training set 602 of application log files 604 is also fed 618 to the untrained LSTM neural network 616. The untrained LSTM neural network 616 is then trained 620 using the training set 602 of application log files 604 and the hyperparameter X to obtain a trained neural network 622.

FIG. 7 shows a schematic representation of a method 700 for detecting anomalous behaviour in a computer system, using the trained neural network 622 shown in FIG. 6. The method 700 receives a real-time stream 730 of application log entries 732, and extracts a sequence 734 of application log entries from the stream 730 of application log entries 732. In the illustrated embodiment, the sequence of application log entries is extracted by applying a sliding window 736 of fixed length to the stream 730 of application log entries 732. The method 700 applies 738 a model 740 comprising the trained neural network 622 to the sequence 734 of application log entries 732 to generate a prediction 742 for a predicted next application log entry. The method 700 compares 744 an actual next application log entry 746 to the prediction 742. If the method 700 determines 748 that the actual next application log entry 746 is outside of the prediction 742, the actual next application log entry 746 is flagged 750 as an anomaly.

As can be seen from the above description, the LSTM neural network training technology described herein represents significantly more than merely using categories to organize, store and transmit information and organizing information through mathematical correlations. The LSTM neural network training technology is in fact an improvement to machine learning applications within the software incident prediction space, as it adapts LSTM neural networks for updates to obviate inaccuracies resulting from unrepresentative initial training data or changes to the application source code. The present technology therefore represents a specific solution to a computer-related problem. As such, the LSTM neural network training technology is confined to machine learning as specifically applied to training and deployment of LSTM neural networks used for software incident prediction.

The processor used in the foregoing embodiments may comprise, for example, a processing unit (such as a processor, microprocessor, or programmable logic controller) or a microcontroller (which comprises both a processing unit and a non-transitory computer readable medium). Examples of computer readable media that are non-transitory include disc-based media such as CD-ROMs and DVDs, magnetic media such as hard drives and other forms of magnetic disk storage, semiconductor based media such as flash media, random access memory (including DRAM and SRAM), and read only memory. As an alternative to an implementation that relies on processor-executed computer program code, a hardware-based implementation may be used. For example, an application-specific integrated circuit (ASIC), field programmable gate array (FPGA), system-on-a-chip (SoC), or other suitable type of hardware implementation may be used as an alternative to or to supplement an implementation that relies primarily on a processor executing computer program code stored on a computer medium.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise (e.g., a reference in the claims to “a training data set” or “the training data set” does not exclude embodiments in which multiple training data sets are used). It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The term “and/or” as used herein in conjunction with a list means any one or more items from that list. For example, “A, B, and/or C” means “any one or more of A, B, and C”.

It is contemplated that any part of any aspect or embodiment discussed in this specification can be implemented or combined with any part of any other aspect or embodiment discussed in this specification.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

1. A method for training a neural network utilizing Long Short-Term Memory (LSTM) to model a computer application log as a natural language sequence, the method comprising:
feeding a training set of application log files to a log file parser;
generating, by the log file parser, a set of X application log clusters, where X is a whole number;
feeding the whole number X to an untrained LSTM neural network as a hyperparameter representing a number of classes; and
training the untrained LSTM neural network using the training set of application log files and the hyperparameter X to obtain a trained LSTM neural network.

2. A computer-implemented method for detecting anomalous behaviour in a computer system, the method comprising:
receiving a real-time stream of application log entries;
extracting a sequence of application log entries from the stream;
applying a model comprising the trained LSTM neural network of claim 1 to the sequence of application log entries to generate a prediction for a predicted next application log entry;
comparing an actual next application log entry to the prediction; and
responsive to determining that the actual next application log entry is outside of the prediction, flagging the actual next application log entry as an anomaly.

3. The method of claim 2, wherein the sequence of application log entries is extracted by applying a sliding window of fixed length to the stream of application log entries.

4. A data processing system comprising at least one processor and memory coupled to the at least one processor, wherein the memory contains instructions which, when implemented by the at least one processor, cause the at least one processor to implement a method for training a neural network utilizing Long Short-Term Memory (LSTM) to model a computer application log as a natural language sequence, the method comprising:
feeding a training set of application log files to a log file parser;
generating, by the log file parser, a set of X application log clusters, where X is a whole number;
feeding the whole number X to an untrained LSTM neural network as a hyperparameter representing a number of classes; and
training the untrained LSTM neural network using the training set of application log files and the hyperparameter X to obtain a trained LSTM neural network.

5. The data processing system of claim 4 wherein the memory contains instructions which, when implemented by the at least one processor, further cause the at least one processor to implement a method for detecting anomalous behaviour in a computer system, the method comprising:
receiving a real-time stream of application log entries;
extracting a sequence of application log entries from the stream;
applying a model comprising the trained LSTM neural network of claim 4 to the sequence of application log entries to generate a prediction for a predicted next application log entry;
comparing an actual next application log entry to the prediction; and
responsive to determining that the actual next application log entry is outside of the prediction, flagging the actual next application log entry as an anomaly.

6. The data processing system of claim 4, wherein the sequence of application log entries is extracted by applying a sliding window of fixed length to the stream of application log entries.

7. A computer program product comprising at least one non-transitory, tangible computer-readable medium embodying computer-usable instructions which, when implemented by at least one processor, cause the at least one processor to implement a method for training a neural network utilizing Long Short-Term Memory (LSTM) to model a computer application log as a natural language sequence, the method comprising:
feeding a training set of application log files to a log file parser;
generating, by the log file parser, a set of X application log clusters, where X is a whole number;
feeding the whole number X to an untrained LSTM neural network as a hyperparameter representing a number of classes; and
training the untrained LSTM neural network using the training set of application log files and the hyperparameter X to obtain a trained LSTM neural network.

8. The computer program product of claim 7, wherein the computer-usable instructions further cause the at least one processor to implement a method for detecting anomalous behaviour in a computer system, the method comprising:
receiving a real-time stream of application log entries;
extracting a sequence of application log entries from the stream;
applying a model comprising the trained LSTM neural network of claim 7 to the sequence of application log entries to generate a prediction for a predicted next application log entry;
comparing an actual next application log entry to the prediction; and
responsive to determining that the actual next application log entry is outside of the prediction, flagging the actual next application log entry as an anomaly.

9. The computer program product of claim 7, wherein the sequence of application log entries is extracted by applying a sliding window of fixed length to the stream of application log entries.
